(19) United States
(12) Patent Application Publication
(10) Pub. No.: US 2014/0342589 A1
(43) Pub. Date: Nov. 20, 2014

(54) WEATHER RESISTANT POWER OUTLETS

(71) Applicant: Paul Lin, Strathfield (AU)

(72) Inventor: Paul Lin, Strathfield (AU)

(73) Assignee: KOLEX PTY LTD, Strathfield, New South Wales (AU)

(21) Appl. No.: 14/235,280

(22) PCT Filed: Jul. 24, 2012
(86) PCT No.: PCT/AU2012/000873

§ 371 Date: Mar. 5, 2014

(30) Foreign Application Priority Data
Jul. 26, 2011 (AU) 2011204973

(51) Int. Cl. H01R 13/52; H01R 13/70; H01R 13/717

(52) U.S. Cl. CPC H01R 13/5213; H01R 13/717; H01R 13/70
USPC 439/142

(57) ABSTRACT

A General Power Outlet (GPO) is provided having a hinged cover and integrally formed side walls forming a moisture drip line. Waterproof and electrically insulated seals protect rocker switches. Located behind pin apertures is a waterproof and electrically insulated elastomeric body having self-closing pin slots. Without inserting a plug, the elastomeric body still seals the apertures completely like a gasket. The pivot structure of the lid bevels and rounds the top of the back of the lid. This allows the top of lid to be level with the wall and the base of the body when it is fully opened at horizontal position. A wall gasket serves as a weatherproof sealer between the GPO and the wall when the invention is installed.

### FIELD OF THE INVENTION

This invention relates to weather resistant power outlets. This invention has particular application to weather resistant general power outlets (GPO), and for illustrative purposes the Invention will be described with reference to this application. However we envisage that this invention may find use in other applications such as weather resistant power outlets mounted on plant and equipment, and portable power outlets (PPO).

### BACKGROUND OF THE INVENTION

The reference to any prior art in this specification is not, and should not be taken as, an acknowledgement or any form of suggestion that the referenced prior art forms part of the common general knowledge in Australia.

The provision of GPOs for exterior use requires providing the GPO with a degree of weather resistance. By regulation, the power sockets and switches used in wet/damp areas and in outdoor areas require waterproofing in order to prevent fluid, dust particles or third party from getting inside the socket and inner assembly. Conventional weatherproof power sockets or switches are generally surface mounted and accordingly bulky to maintain weatherproof rating. Currently, there is no weatherproof model comparable in profile and presentation to interior GPOs such as flush mount GPOs.

Prior art weatherproof GPOs are shown in comparative FIGS. 1 and 2. FIG. 1 illustrates a conventional weatherproof power socket which is a bulky device with significant projection from wall of least 72 mm. The large upper surface area of this device collects dust. The projection from wall in use can hamper people's movement. The projection from the surface is as visually unappealing as it is bulky. The socket outlet is located at the bottom of the device at an angle to prevent contact with rain. The user is required to blindly insert the electrical plug at an angle in. This is often a trial and error process as the socket outlet is not well visualized in contrast to an indoor power socket where the socket faces the user. The entry pin holes of the socket outlet are environmentally protected to a degree but remain open holes, resulting in limited weatherproof rating. Splashing or spraying fluid, dust particles and insect can still get inside the socket. The device does not prevent children from inserting metal objects into the socket.

FIG. 2 Illustrates an alternative but still conventional weatherproof enclosure box including a hinge door. The weatherproofing aspects are entirely embodied in the enclosure, not in the GPO per se. The hinge door has an external hinge that can be easily broken. The enclosure lid needs to be opened before inserting the electrical plug. In an installation with two power sockets, the aperture of the second socket remains exposed when only one socket is used. In a typical installation of this enclosure, an indoor power point or switch is often used inside the enclosure. An indoor power point or switch has rocker switches that are not sealed resulting in a weatherproofing weak spot. Some designs attach a rubber cover over the power switch using adhesive glue. Over time, the rubber cover becomes loose and loses its weatherproof protection.

In a third embodiment of prior art GPOs, in order to prevent accidental insertion of object into power socket by children, a safety shutter may be employed by some designs. The safety shutter is a mechanical stop that is moved and opened by correct insertion of the plug pins. Upon insertion of the (longer) earth pin, shutters inside the active and neutral apertures are opened. The safety shutter is constructed of hard plastic that it is not waterproof and dustproof. Due to the nature of design, the power sockets have tight aperture and insertion of power plug is difficult.

### SUMMARY OF THE INVENTION

In one aspect the present invention resides broadly in a weather resistant power outlet including:
a plate having an array of pin apertures adapted to receive conductor pins of an electrical male plug, mounting means for securing the plate to a surface, and gasket means substantially sealing said plate to said surface;
a socket assembly mounted to the inside of said plate and having conductor pin engaging electrical terminals in register with said pin apertures and wiring terminals;
an elastomeric body sealing said apertures from said socket assembly and having openings allowing passage of conductor pins of an electrical male plug passing through said pin apertures to electrically engage said conductor pin engaging electrical terminals, the body and its openings being selected to be self-sealing on withdrawal of said plug.

### DESCRIPTION OF THE INVENTION

The plate may be a wall plate, a plate adapted for use with a surface mount box, a plate adapted for mounting to plant or equipment, or may be a plate adapted for incorporation in a tradesman's remote power outlet. The mounting means may comprise a pair, of mounting screws, either located in pluggable screw wells through the plate front face or concealed under a snap-on ring. The plate may be a single point plate or a double point plate. The plate may include glued or snap-in lens/diffusers for an on-indicator lamp. In the case of a snap-in lens/diffuser, this may be replaced by an on-indicator lamp including an elastomeric seal located in an aperture and into which an indicator lamp may be pressed. For example a top hat section elastomeric seal, into which an indicator LED may be pressed, may provide a weatherproof indicator lamp configuration.

The array of pin apertures may take any form mandated by regulations governing power outlets including presence or absence of an earth pin (for double insulated appliances), pin section and pin geometry.

The means securing the plate to a surface may take any form determined at least in part by the substrate and including but not limited to screws, metal threads and the like. Penetrating fixings may be associated with O-rings or resilient washers to enhance water tightness of the plate-to-substrate enclosure.

The gasket means may be selected having regard to the shape of the mating surface of the plate and/or the nature of the substrate surface. The gasket may be of an elastomeric material such as natural or synthetic rubber, or may be a compressible gasket material such as cork composition. The gasket may comprise a chemically resistant elastomeric material selected from but not limited to silicone rubber, nitrite rubber or Thiokol rubber.

The socket assembly may be a switched or unswitched socket assembly. In the case of a switched socket assembly, this may be formed integrally with a switch such as a rocker switch or may be wired to a separate switch assembly. The plate may be of the type where the pin apertures are part of an underplate and the rocker switch aperture(s) are provided in a trim panel that snaps over the underplate. Alternatively the plate may be of the more conventional type where the rocker switch aperture(s) and the pin apertures are provided in the dress face of a unitary ABS chassis and where the fixings are through pluggable screw recesses.

The elastomeric body may be formed of any elastic and durable material which can stand for reasonably high voltage and temperature. For example, the elastomer may be selected from elastomers of rated dielectric strength such as selected natural or synthetic rubber compositions such as neoprene, and elastomeric artificial polymers such as silicone and polyurethane rubbers. The elastomeric body may be located between the plate and the socket assembly. That is, the body may be secured by entrapment between the plate and the socket assembly. Alternatively or additionally the elastomeric body may be adhered to one or both of the plate and socket assembly.

Clearance between the elastomeric body and one or the other of the plate and socket assembly may be employed to allow working room for a conventional safety shutter mechanism.

In a yet further embodiment or combination, the elastomeric body may be engaged with the plate and/or socket assembly by complementary engagement means. By any of these means the terminals of the socket assembly may be sealingly isolated from the pin apertures to provide a first level of weather resistance.

The openings through the body may comprise slits that are naturally closed in a weatherproof manner by the resilience of the elastomeric body. The closing of the slits may be achieved or enhanced by mounting the elastomeric body under compression. The body remains closed when a plug is not in use thus preventing exposure to air, fluid, dust particles, insect and metal. When a plug is inserted, the flexibility of the gasket acts as a firm enclosure holding all pins, leaving no gap surrounding the plug pins and limiting exposure to air, fluid, dust particles, insect and metal. The elastomeric body yield strength, dimensions and opening characteristics may be selected to resist insertion of foreign objects by children.

The apparatus may be waterproof in terms of environmentally isolating the inside of the power outlet from the ingress of water impinging on the outside of the mounted power outlet, or the apparatus may be weather resistant in terms of actively and/or passively resisting the effects of weather. For example there may be provided a drain hole or the like as a lower water trap portion of the power outlet assembly. This may be especially applicable in embodiments where the elastomeric body is sealed to the socket assembly allowing possible passage of moisture through the pin apertures.

In the case of switched power outlets, the integral or separate switch assembly may be exposed for use through a switch aperture formed in the plate. In conventional GPO switchgear this is a rocker switch, although in specialist applications a rotary switch, toggle switch, push switch or momentary switch may be used.

The type of switch may influence the nature of weather-resisting modification that is appropriate. For example where the socket assembly is switched by a rocker switch exposed through a switch aperture in the plate, there may be provided an elastomeric weather seal having a web extending over the rocker switch and a peripheral edge adapted to sealingly engage the periphery of the switch aperture. The peripheral edge may comprise a substantially continuous, re-entrant edge adapted to pass over and sealingly engage the periphery of the switch aperture.

The weather resistant power outlet may further include a cover to provide further weatherproofing.

In the case of at least conventional rocker switches, there are two levels of resistance that need to be achieved, which are resistance to weather infiltrating the switch per se, and resistance to weather infiltrating past the switch assembly to the interior of the mounted plate to affect other components. It is known to stick an elastomeric cover to the plate and overlaying the rocker switch finger button. However, this solution is prone to failure.

It has surprisingly been determined that a historical artefact of GPO manufacture is that increasing precision of moulded components has not resulted in close tolerances in the relatively moving parts of the rocker switch assembly and the wall and other plates. With a corresponding increase in the available precision of rubber mouldings, the present applicant has determined that a functional weatherproofing cover for a rocker switch is possible.

Accordingly in a further aspect the invention resides in a rocker switch assembly including a rocker switch mounted to said switch mounting plate, a rocker exposed through an aperture in said switch mounting plate, and an elastomeric weather seal having a web extending over said rocker and a substantially continuous, re-entrant edge adapted to sealingly engage the periphery of said aperture.

The elastomeric weather seal may be used in conjunction with the weatherproof GPO described above. The elastomeric weather seal may be formed integrally with the elastomeric body.

The elastomeric weather seal acts as an insulated cover to prevent exposure to fluid and dust particles. The elastomeric weather seal acts as an insulated cover to protect the user from electric arc and potential shock when the button is used to turn on/off under adverse weather conditions for electrical switches.

In alternative uses the elastomeric weather seal may be used for light switch plate weatherproofing, whether in association with a plate-to-substrate gasket as described above or other weatherproofing features.

GPO and light switches in accordance with the present invention may be used with or without a cover and still provide a high waterproof rating. Where a cover is desirable to provide additional resistance and/or physical protection, this may be conventional. However, as the assemblies of the present invention are slim-line, there are improvements to covers to be made to maintain the slim-line look and increase cover functionality.

Accordingly, in a further aspect the invention relates to an electrical switch assembly including:
a plate having a peripheral edge adapted to bear on a substrate in use and a front face spaced from said peripheral edge by an upper wall portion having a drainage rib formed adjacent said front face keeping liquid on said upper wall portion away from said front face;
an electrical component secured to and accessed through an aperture in said front face, and
a cover having a peripheral flange portion and hinged to said top wall to be movable between a substantially horizontal open position with said flange portion adjacent said substrate and providing access to said aperture and a closed position protecting said aperture and having said peripheral flange overlay said upper wall portion.

The plate may be a wall plate as described above. The plate may be slim-line. The peripheral edge may be fitted off with a gasket as described above. The upper wall portion may extend about the periphery at a substantially constant width or may include tapered side portions and a relatively narrow bottom portion. The drainage rib may be integrally moulded with the plate and may comprise an upstanding rib or a rib remaining after relief of the upper wall portion behind the front face. The upper wall portion may extend between two side wall portions whereby the rib may confine water flow to either side of the upper wall portion.

The electrical component may comprise one of more of a switch, a socket or and indicator light. The electrical component may comprise a weather resistant power outlet as described above.

The cover may be formed of rigid or resilient polymer material or be of metal or FRP. The flange portion may extend substantially about the periphery of the cover.

The cover preferably hinges about an axis as close as possible to the outer edge of the flange, and the corresponding pivot axis on the upper wall is preferably intermediate the rib and the peripheral edge inner junction of the flange and cover, the intermediate position may be selected to be far enough from the substrate whereby the cover is opened to at least the horizontal before the flange contacts the substrate and is as close to the substrate as allows the cover to close over the plate with the flange edge adjacent the substrate.

In embodiments of the present invention the plate and cover assembly when installed may project as, little as 19 mm from the substrate, close to the width and height of a normal indoor power socket or switch. This is opposed to the 16 mm in thickness of the inventive plates without a cover, representing a depth penalty of only 3 mm. this is to be contrasted with the conventional covered weatherproof power socket with a 72 mm thickness. The hinge on the lid of the invention is not visible externally, it result in sleek appearance.

Features in accordance with the foregoing may be incorporated into portable power outlets (PPO). For example, a conventional PPO carcase may be retrofitted with one or more of a weatherproof GPO and/or rocker switch assembly and/or electrical switch assembly as described above.

In a further aspect the invention resides in a portable power outlet including:
a pair of body portions each having a mounting surface thereon for a weather resistant power outlet, and each having opposed and complementary mounting portions for a cable entry and an RCD mount respectively, the body portions being adapted to be screwed together and having complementary mating surfaces defining a partition line;
a gasket selected to cooperate with said mating surfaces to seal said partition line in assembly and including a sealing portion about said RCD mount;
a weather resistant power outlet on each surface and including a plate having an array of pin apertures adapted to receive conductor pins of an electrical male plug and a rocker switch aperture, mounting means for securing the plate to the surface, gasket means substantially sealing said plate to said surface, a socket assembly mounted to the inside of said plate and having conductor pin engaging electrical terminals in register with said pin apertures and wiring terminals, an elastomeric body sealing said apertures from said socket assembly and having openings allowing passage of conductor pins of an electrical male plug passing through said pin apertures to electrically engage said conductor pin engaging electrical terminals, the body and its openings being selected to be self-sealing on withdrawal of said plug, a rocker switch exposed through said rocker switch aperture, and an elastomeric weather seal having a web extending over said rocker switch and a substantially continuous, re-entrant edge adapted to sealingly engage the periphery of said rocker switch aperture;
a double insulated supply cable adapted to sealingly engage with said complementary cable entry mounting portions; and
an RCD mounted to said RCD mount and substantially sealed about its periphery by said sealing portion about said RCD mount.

The pair of body portions may be the carcass of a conventional PPO. Such devices may include a partition line defined by complementary interengagement portions formed on the mating edges of the parts. The gasket may be configured to engage with one or both of the complementary interengagement portions. The gasket may be unitary or formed of two or more gasket portions.

The RCD mount will be determined by the type of RCD to be used. The weather resistant power outlet may be selected from the above described weather resistant power outlets. The weather resistant power outlets may include a cover which may be selected from the covers described above.

The RCD may be a conventional RCDMCB, incorporating the functions of both residual current (earth leakage) protection and current-overload protection. Such units generally comprise a standard DIN-rail mountable RCDMCB where integral opposed projections formed on each of the body portions engage the DIN mount of the RCD on assembly of the body portions. The body portions may each include a recess forming in assembly the opposed pivot points for a conventional RCD protective cover. The sealing portion about said RCD mount may be configured as a compression seal or as a lip seal.

### BRIEF DESCRIPTION OF THE DRAWINGS

The invention will be described with reference to the following non-limiting embodiment of the invention as illustrated in the drawings and wherein:

FIG. 1 is a conventional (prior art) weatherproof power socket for comparison purposes;

FIG. 2 is the alternative prior art of a weather resistant enclosure box with a hinged cover;

FIG. 3 is a perspective view of a weather resistant power outlet in accordance with the present invention, cover closed;

FIG. 4 is a perspective view of the weather resistant power outlet of FIG. 3, with the cover open;

FIG. 5 is a side section view of the apparatus of FIG. 4;

FIG. 6 is a rear view of the apparatus of FIGS. 3 and 4;

FIG. 7 is a perspective view of the apparatus of FIGS. 3 and 4, in use;

FIG. 8 is a side section view of the apparatus of FIG. 3;

FIG. 9 is a perspective view of the elastomeric body of the apparatus of FIGS. 3 and 4;

FIG. 10 is a partial section through the apparatus of FIGS. 3 and 4, showing electrical plug insertion in use;

FIG. 11 is a plan view of a rocker switch elastomeric weather seal used in the apparatus of FIGS. 3 and 4;

FIG. 12 is a perspective view of the weather seal of FIG. 11;

FIG. 13 is a detailed side cross section of the apparatus of FIGS. 3 and 4, showing the weather seal of FIG. 11 in use;

FIG. 14 is a rear view of the apparatus of FIGS. 3 and 4, showing a wall gasket;

FIG. 15 is a section of a cover plate of an alternative GPO plate, in this embodiment used in a PPO;

FIG. 16 is a detail section of an indicator lamp assembly for weatherproof use with the plate of FIG. 15;

FIG. 17 is a front elevation of the seal partition line of a PPO in accordance with the present invention;

FIG. 18 is a sectional and exploded end elevation of the apparatus of FIG. 17;

FIG. 19 is a side view of the PPO of FIGS. 17 and 18; and

FIG. 20 an interior detail of the PPO of FIG. 19.

### DESCRIPTION OF THE PREFERRED EMBODIMENTS

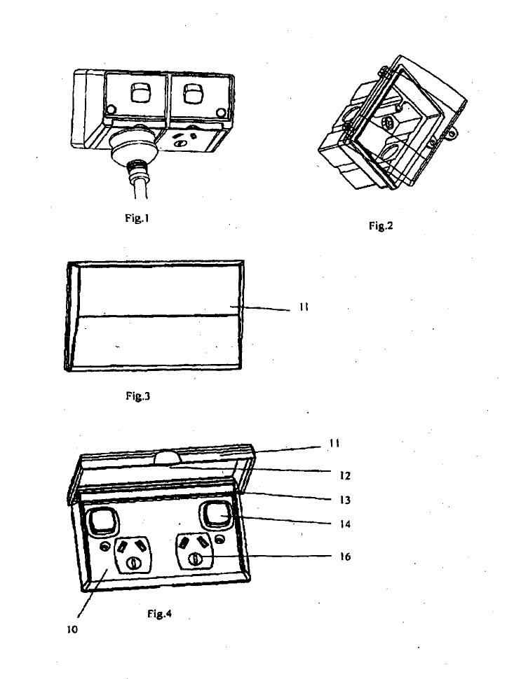

In the comparative FIG. 1 and FIG. 2, there are illustrated alternative prior art methods of providing weather resistance for general power outlets (GPO).

In the example of FIG. 1, there is provided an integrated double GPO comprising a weatherproof enclosure having weather resisting switches and downward-facing open sockets. The open sockets are bounded by integrally moulded drip lines.

In the comparative example of FIG. 2, there is shown an enclosure for a conventional wall plate and having a hinged cover.

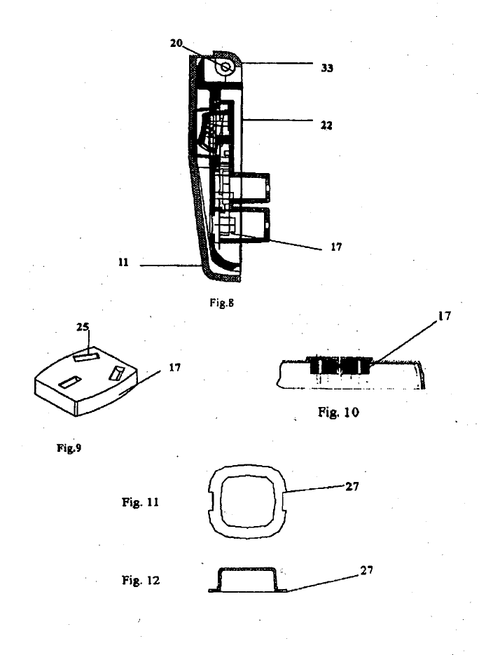

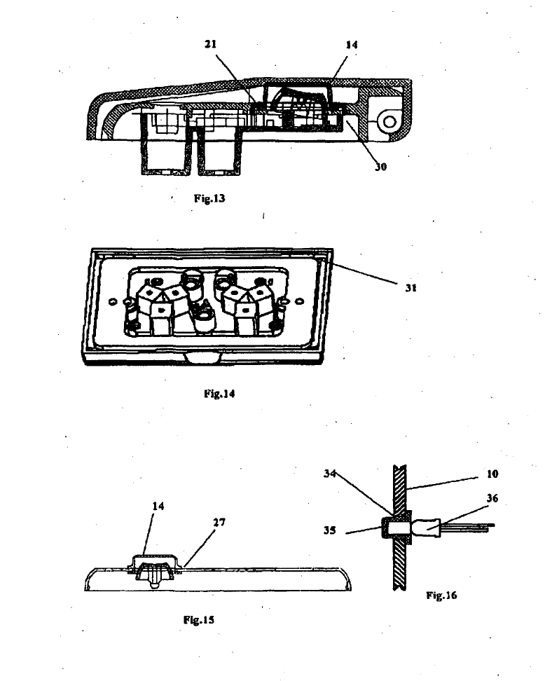

In the FIGS. 3 to 14 there is illustrated a first embodiment of the present invention, wherein there is provided a double-GPO wall plate 10 having a hinged cover 11. A latching bead 12 on the cover edge secured the cover in a closed position. Integrally formed side walls 13 form a moisture drip line protecting the plate face. Elastomeric switch seals 14 protect rocker switches 15. The GPO function is defined by pin apertures 16, comprising active (a) and neutral (N) apertures symmetrically disposed either side of an axis passing through an earth (E)-aperture.

Located behind the pin apertures 16 is an elastomeric body 17 having self-closing, lead-in pin slots 25.

The cover 10 covers the inserted plug 26 as depicted in FIG. 7. The two side wings 13 allow the fluid from top to flow down the sides without contacting the plug or the sockets as depicted in FIG. 7. The soft and flexible rubber cover 14 on rocker button 15 is waterproof and electrically insulated. The elastomeric body 17 under the entry pin holes 16 is waterproof and electrically insulated.

FIG. 9 shows the structure of elastomeric body 17. The elastomeric body 17 is made of firm and flexible material with three split slots 25 for the three plug pins to go through. The elastomeric body 17 is flexible that upon insertion of the plug pins 26 it immediately encloses the pins 26. The slots 25 allow pins 26 to insert and seals the pins 26 completely. Without inserting the plug, the elastomeric body 17 still seals the apertures 16 completely like a gasket. This also results a safer power point and limits accidental insertion of metal objects by children. Conclusively the invention provides weather protection whether the electrical device is plugged or not.

A clearance between the rocker switch button 15 and the body of the switch is necessary to permit rocker movement, but this gap also allows fluid and dust particles to enter the switch mechanism. During the switching of the switch rocker 15, electric spark is sometimes generated, through this gap; the user runs the risk of electrocution, especially in an outdoor area or wet area. The invention has a flexible button enclosure 14 that completely insulates the user from the internal switching mechanism while allowing rocker movement. The flexible button enclosure 14 covers the top of the rocker button 15. In addition, a skirt flange 27 surrounds the bottom of the flexible button enclosure 14. The skirt flange 27 is pressed and held by an enclosure holder 21 which is constructed of hard plastic and having a one-way retaining barb 30. In the alternative embodiment of FIG. 15 the skirt flange 27 provided with an annular groove, to enable self-retention without the need for an enclosure holder.

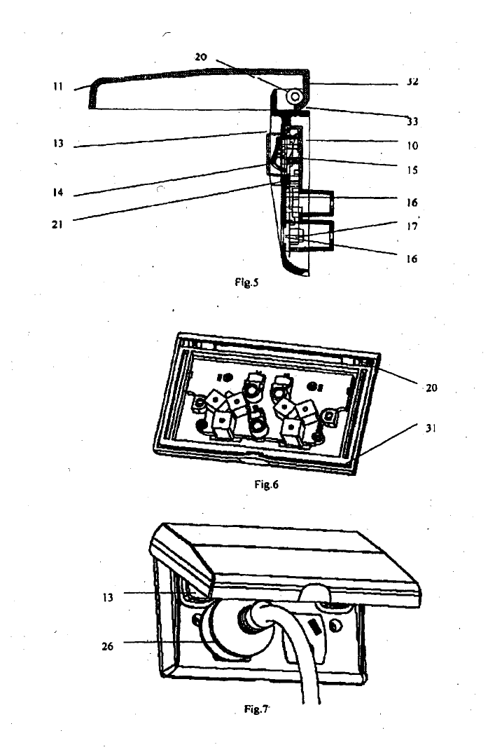

The lid on a conventional weatherproof enclosure box with a hinge cannot fully open to a horizontal position. The lid is stopped by the contact to the wall opening to a full horizontal position. The invention moves back the pivot 20 8 mm away from the top side of the body of the switch, and bevels and rounds the top of the back of the lid at 33. This allows the top 32 of lid 11 to be level with the wall and the base of the body 10 when it is fully opened at horizontal position. This is depicted in FIG. 5.

The hidden hinge 20 is depicted in FIG. 6. The position of the hidden hinge 20 allows the lid 10 to fully cover the socket body. This creates a neat, compact, and stylish external appearance. Normally people have the hinge 20 pivot axis on the side edge of body or the two sides of lid; the new design is to set the pivot axis on the top of body, hidden by the lid 10. Thus the hinge 20 becomes invisible.

A latch 12 is positioned at the central bottom of lid 10. The latch 12 hooks the lid 10 to the body of the switch. This prevents the movement of the lid 10 when it is closed.

A wall gasket 31 serves as a weatherproof sealer between socket body 10 and the wall when the invention is installed.

In embodiments where an indicator lamp is required, as illustrated in FIG. 16 there is provided a lamp aperture 34 into which an elastomeric top-hat section grommet 35 is pressed. An LED 36 is pressed into the grommet from behind the plate 10 and is wired to the voltage drop across a resistor (not shown) in parallel with the switched load circuit.

Apparatus in accordance with the foregoing embodiment provides a high waterproof rating of, say, over IP55, in a power socket or switch that is less than 20 mm thick from wall. The high waterproof rating power socket or switch does not rely on extra save, or an external enclosure box to achieve its rating. The high waterproof rating power socket offers front facing direct plug insertion rather than at an angle. The high waterproof rating power socket or switch may have or not have a cover. It is weatherproof with or without plug inserted. It allows a power plug to be inserted while maintaining a tight seal around the power plug pins to achieve waterproof rating. It resists children from inserting metallic object into power sockets. The embodiment has an elastomeric body that is fixed and secured to the body of the power point or switch, not glued. The embodiment has its switch mechanism enclosed by an enclosure that is flexible and allows the covered switch button enclosed within to move. The lid of the preferred embodiment has substantially no gap between wall and power socket or switch, while able to open up to a horizontal position without the lid impinging on the wall.

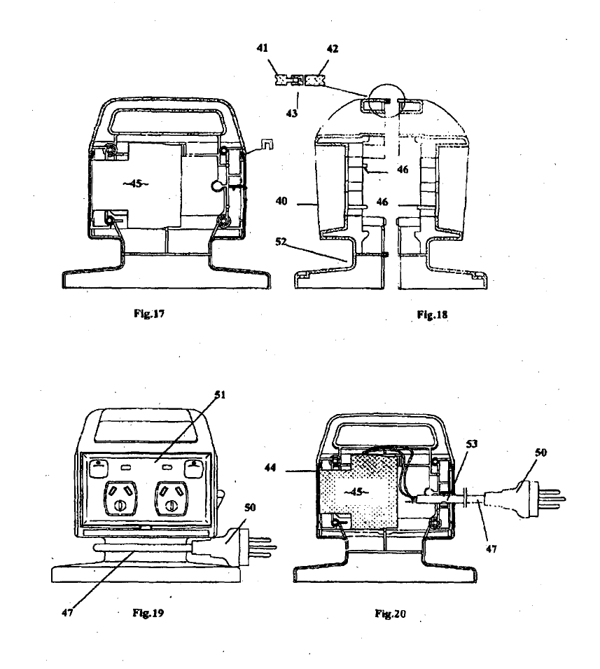

In the embodiment of FIGS. 17 to 20, there is provided a portable power outlet including opposed housing portions 40, one of which has a ridged mating edge 41 and the other having a plain mating edge 42. A grooved gasket 43 seals the mating edges together in assembly. The gasket 43 includes a widow portion 44 adapted to seal against the body of an RCD 45 located in complementary portions of the housing portions 40 by lugs 46 adapted to engage the DIN mounting profile of the RCD 45.

A double insulated cable 47 is terminated by a three-pin plug 50 and is wired appropriate to the RCD 45 and a pair of weatherproof power outlets 51 mounted on gaskets to a respective recesses platform 52 formed on each housing portion 40. The cable 47 passes thought a weatherproof gripper labyrinth cable entry 53.

It will of course be realised that while the above has been given by way of illustrative example of this invention, all such and other modifications and variations thereto as would be apparent to persons skilled in the art are deemed to fall within the broad scope and ambit of this invention as is set forth in the claims appended hereto.

1. A weather resistant power outlet including:
a plate having an array of pin apertures adapted to receive conductor pins of an electrical male plug, mounting means for securing the plate to a surface, and gasket means substantially sealing said plate to said surface;
a socket assembly mounted to the inside of said plate and having conductor pin engaging electrical terminals in register with said pin apertures and wiring terminals;
an elastomeric body sealing said apertures from said socket assembly and having openings allowing passage of conductor pins of an electrical male plug passing through said pin apertures to electrically engage said conductor pin engaging electrical terminals, the body and its openings being selected to be self-sealing on withdrawal of said plug.

2. A weather resistant power outlet according to claim 1, wherein the plate is selected from a wall plate, a plate adapted for use with a surface mount box, a plate adapted for mounting to plant or equipment, and a plate adapted for incorporation in a tradesman's remote power outlet.

3. A weather resistant power outlet according to claim 1, wherein said plate includes an on-indicator lamp including an elastomeric seal located in an aperture and into which an indicator lamp is pressed.

4. A weather resistant power outlet according to claim 1, wherein said socket assembly is formed integrally with a switch.

5. A weather resistant power outlet according to claim 1, wherein said elastomeric body is formed of an elastomer of rated dielectric strength.

6. A weather resistant power outlet according to claim 5, wherein said elastomeric body is secured by entrapment between the plate and the socket assembly.

7. A weather resistant power outlet according to claim 5, wherein said elastomeric body is engaged with the plate and/or socket assembly by complementary engagement means.

8. A weather resistant power outlet according to claim 5, wherein said openings through the body comprise slits that are naturally closed in a weatherproof manner by the resilience of the elastomeric body.

9. A weather resistant power outlet according to claim 8, wherein closure of said slits is achieved or enhanced by mounting the elastomeric body under compression.

10. A weather resistant power outlet according to claim 1, wherein said socket assembly is switched by a rocker switch exposed through a switch aperture in said plate, and including an elastomeric weather seal having a web extending over said rocker switch and a substantially continuous, re-entrant edge adapted to sealingly engage the periphery of said switch aperture.

11. A weather resistant power outlet according to claim 1, and further including a cover to provide further weatherproofing.

12-14. (canceled)

15. An electrical switch assembly including:
a plate having a peripheral edge adapted to bear on a substrate in use and a front face spaced from said peripheral edge by an upper wall portion having a drainage rib formed adjacent said front face keeping liquid on said upper wall portion away from said front face;
an electrical power outlet according to claim 1, secured to and accessed through an aperture in said front face, and
a cover having a peripheral flange portion and hinged to said top wall to be movable between a substantially horizontal open position with said flange portion adjacent said substrate and providing access to said aperture and a closed position protecting said aperture and having said peripheral flange overlay said upper wall portion.

16. An electrical switch assembly according to claim 15, wherein the electrical power outlet comprises a switched said socket assembly.

17. An electrical switch assembly according to claim 15, wherein the peripheral edge is fitted off with a gasket.

18. An electrical switch assembly according to claim 15, wherein the upper wall portion extends about the periphery at a substantially constant width.

19. An electrical switch assembly according to claim 15, wherein the drainage rib is integrally moulded with the plate.

20. An electrical switch assembly according to claim 15, wherein the cover is formed of rigid or resilient polymer material.

21. An electrical switch assembly according to claim 15, wherein the cover hinges about an axis adjacent the outer edge of the flange, and the corresponding pivot axis on the upper wall is at an intermediate position between the rib and the peripheral edge inner junction of the flange and cover, said intermediate position being selected to be far enough from the substrate whereby the cover is opened to at least the horizontal before the flange contacts the substrate and is as close to the substrate as allows the cover to close over the plate with the flange edge adjacent the substrate.

22. A portable power outlet including:
a pair of body portions each having a mounting surface therein for a weather resistant power outlet, and each having opposed and complementary mounting portions for a cable entry and an RCD mount respectively, the body portions being adapted to be screwed together and having complementary mating surfaces defining a partition line;
a gasket selected to cooperate with said mating surfaces to seal said partition line in assembly and including a sealing portion about said RCD mount;
a weather resistant power outlet according to claim 10 on each surface;
a double insulated supply cable adapted to sealingly engage with said complementary cable entry mounting portions; and
an RCD mounted to said RCD mount and substantially sealed about its periphery by said sealing portion about said RCD mount.

23. A portable power outlet according to claim 22, wherein said pair of body portions separate at a partition line defined by complementary interengagement portions formed on the mating edges of the body portions, and wherein the gasket is configured to engage with one or both of the complementary interengagement portions.

24. A portable power outlet according to claim 23, wherein said gasket is selected from a unitary gasket or a set of two or more gasket portions.

25-26. (canceled)

27. A portable power outlet according to claim 22, wherein the sealing portion about said RCD mount is configured as a seal selected from a compression seal or a lip seal.
